(19) United States
(12) Patent Application Publication
(10) Pub. No.: US 2025/0044771 A1
(43) Pub. Date: Feb. 6, 2025

(54) DISPLAY CONTROL DEVICE AND MACHINE TOOL

(71) Applicant: DMG MORI CO., LTD., Nara (JP)

(72) Inventors: Megumi OYA, HOKKAIDO (JP); Junjiro ENOMOTO, HOKKAIDO (JP); Toshitaka NAGANO, HOKKAIDO (JP)

(73) Assignee: DMG MORI CO., LTD., Nara (JP)

(21) Appl. No.: 18/718,056

(22) PCT Filed: Dec. 6, 2022
(86) PCT No.: PCT/JP2022/044860

§ 371 Date: Jun. 9, 2024

(30) Foreign Application Priority Data
Jan. 7, 2022 (JP) 2022-001683

(51) Int. Cl. G05B 19/416; G05B 19/409

(52) U.S. Cl. CPC G05B 19/416; G05B 19/409

(57) ABSTRACT

A display control device according to an embodiment includes a display control unit for controlling display of time-series data indicating a change in a detected value detected by the detection unit in a process of execution of a machining program, and a receiving unit for receiving a predetermined input based on the time-series data. The display control unit controls display of (a) a program name and (b) at least one of a block number and a program line of the machining program associated with the predetermined input received by the receiving unit.

### TECHNICAL FIELD

The present invention relates to a display control technology for supporting measures against chatter vibrations occurring in machine tools.

### BACKGROUND ART

A chatter vibration occurring in machine tools leads to a decrease in the quality of a machined surface of a workpiece. It is therefore important to reduce occurrence of chatter vibrations. There are a variety of causes of chatter vibrations. A source of a vibration may be a tool or a workpiece. In many cases, operators take actions based on their own experience to find and remove the causes thereof. For example, an operator may listen to the vibration sound and observe the machined surface of a workpiece to predict the cause of a chatter vibration, and adjust the rotating speed or the feed rate of a spindle, or the depth or the width of cut of a tool. When the chatter vibration does not converge after the adjustment, the operator may attempt to change the way of fixing the workpiece or to change the tool. Such measures are selected on the basis of the operator's own experience and knowledge.

There are several factors of chatter vibrations. Major factors are regenerative chatter resulting from a change in thickness of cut of the tool caused by undulations of the machined surface due to a vibration, and forced chatter caused by resonance based on a natural frequency. A technology for supporting operator's operation to make such chatter vibrations converge has been proposed (see PTL 1).

### CITATION LIST

### Patent Literature

PTL 1: JP 6456434 B

### SUMMARY OF INVENTION

### Technical Problem

It is desirable that an operator record operations in detail so that it can be determined afterwards when a chatter vibration occurred, whether measures against the chatter vibration taken by the operator have been effective, and what operations have been performed when a measure has been effective. Such records facilitate efficient convergence of subsequent chatter vibrations. It is desirable that a position where a chatter vibration has occurred and details of changes made on settings as measures against the chatter vibration can be concretely checked afterwards.

### Solution to Problem

An embodiment of the present invention is a display control device for controlling display of a state of a machine tool which includes (i) an attachment portion to which a tool is attachable, (ii) a numerical control unit for controlling a rotating speed of the tool in accordance with a machining program, and (iii) a detection unit for detecting at least one of a vibration of the tool and a load applied to the tool. The display control device includes a display control unit for controlling display of time-series data indicating a change in a detected value detected by the detection unit in a process of execution of the machining program, and a receiving unit for receiving a predetermined input based on the time-series data. The display control unit controls display of (a) a program name and (b) at least one of a block number and a program line of the machining program associated with the predetermined input received by the receiving unit.

### Advantageous Effects of Invention

According to the present invention, it is possible to provide display that supports measures against a chatter vibration to be taken by an operator during use of a machine tool.

### BRIEF DESCRIPTION OF DRAWINGS

FIG. 1 is a perspective view illustrating a schematic configuration of a machine tool according to an embodiment.

FIG. 2 is a diagram schematically illustrating an electrical configuration of functional units involved in detection of a chatter vibration.

FIG. 3 is a functional block diagram of a control unit.

FIG. 4 is a diagram illustrating a management screen for managing a state of control performed by a control device.

FIGS. 5A and 5B are diagrams illustrating a tuning screen and a status screen.

FIGS. 6A and 6B are diagrams illustrating status screens after screen switching.

FIG. 7 is a diagram illustrating an example of a screen that can be displayed in a vibration control process.

FIG. 8 is a diagram illustrating an example of a screen that can be displayed in the vibration control process.

FIG. 9 is a diagram illustrating a change history check screen that can be referred to by an operator afterwards.

FIGS. 10A to 10C illustrate an example of a process of updating a machining program.

FIG. 11 is a diagram illustrating a state in which a program check screen is displayed.

FIG. 12 is a flowchart of a vibration control process.

FIG. 13 is a flowchart of a spindle-rotating-speed adjustment process.

FIG. 14 is a flowchart of a change history check process.

FIG. 15 is a flowchart of a program check display process.

FIGS. 16A and 16B are diagrams illustrating a change history check screen according to a first modification.

FIGS. 17A and 17B are diagrams illustrating screen transition of a program check screen.

FIGS. 18A and 18B are diagrams illustrating screen transition of a program check screen.

FIG. 19 is a sequence diagram of a change history check process according to a second modification.

FIGS. 20A and 20B are diagrams illustrating screen transition of a program check screen according to a third modification.

FIGS. 21A and 21B are diagrams illustrating screen transition of a program check screen according to a fourth modification.

### DESCRIPTION OF EMBODIMENTS

An embodiment of the present invention will now be described below with reference to the drawings.

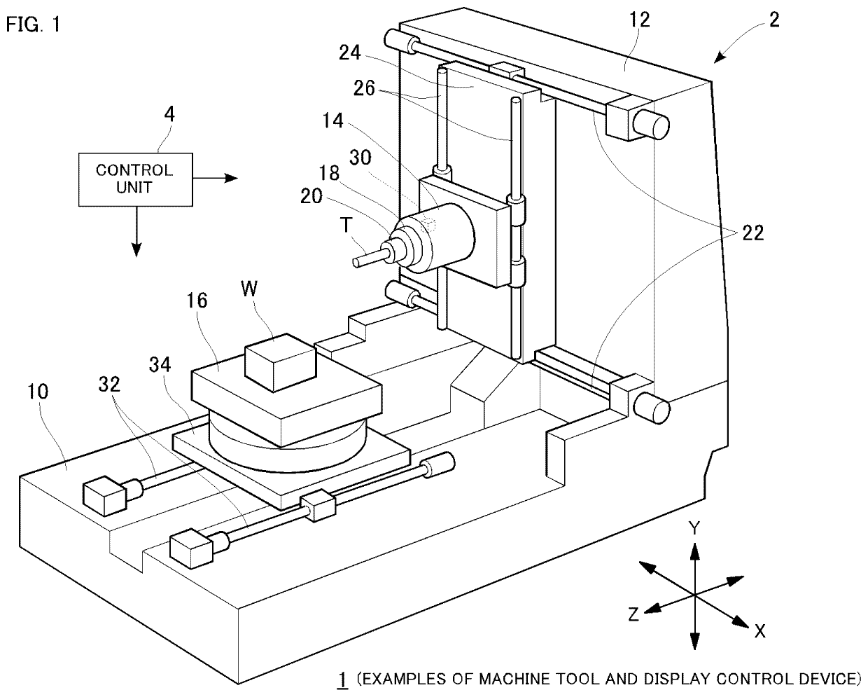

FIG. 1 is a perspective view illustrating a schematic configuration of a machine tool according to an embodiment. Herein, the left-right direction, the up-down direction, and the front-back direction when a machine tool 1 is viewed from the front will be referred to as an X-axis direction, a Y-axis direction, and a Z-axis direction, respectively.

The machine tool 1 is a horizontal machining center and includes machining equipment 2 and a control unit 4. A housing (not illustrated) is provided to cover the machining equipment 2. A console is provided on a side surface of the housing. The console includes a touch panel (described later) that can be operated by an operator.

The machining equipment 2 includes a bed 10, a column 12 provided to stand on the bed 10, a spindle head 14 movably provided on the front surface side of the column 12, and a table 16 movably provided on the bed 10. The spindle head 14 has an axis in the Z-axis direction and supports a spindle 18 to allow the spindle 18 to rotate around the axis. The spindle head 14 is provided with a spindle motor for rotatably driving the spindle 18. The spindle 18 functions as an “attachment portion” to which a tool T held by a tool holder 20 can be coaxially attached. A workpiece W is fixed onto the table 16 via a jig (not illustrated).

Guiderails 22 are provided on the front surface of the column 12, and support a saddle 24 to be movable in the X-axis direction. Guiderails 26 are provided on the front surface of the saddle 24, and support the spindle head 14 to be movable in the Y-axis direction. Movement of the saddle 24 and the spindle head 14 is achieved by a feed mechanism and a servomotor driving the feed mechanism (both not illustrated). The feed mechanism is, for example, a screw feed mechanism using a ball screw. The saddle 24 and the spindle head 14 are driven to move the spindle 18 in the X-axis and Y-axis directions. The spindle head 14 has an acceleration sensor (accelerometer) 30 incorporated therein. The acceleration sensor 30 is used for detecting a chatter vibration of the tool T, details of which will be described later.

In addition, guiderails 32 are provided on the top surface of the bed 10. A saddle 34 is supported by the guiderails 32 to be movable in the Z-axis direction. The table 16 is fixed on the saddle 34. Movement of the saddle 34 is realized by a feed mechanism and a servomotor driving the feed mechanism (both not illustrated). The feed mechanism is, for example, a screw feed mechanism using a ball screw. The saddle 34 is driven to move the workpiece W in the Z-axis direction. Thus, the configuration as described above enables three-dimensional adjustment of relative positions of the workpiece W and the tool T.

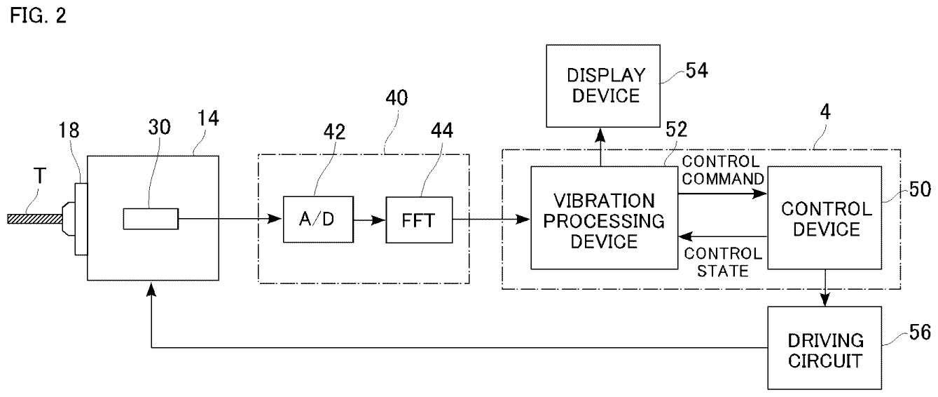

FIG. 2 is a diagram schematically illustrating an electrical configuration of functional units involved in detection of a chatter vibration.

As described above, the spindle head 14 has the acceleration sensor 30 incorporated therein. The acceleration sensor 30 detects a vibration occurring at the tool T during machining of the workpiece W, and outputs a signal depending on the vibration. An acceleration detected by the acceleration sensor 30 (more specifically, an electrical signal indicating the acceleration) is input to a signal processing device 40.

The signal processing device 40 includes an A/D converter 42 and a frequency analyzing device 44 that are mounted on a dedicated board. On a signal output from the acceleration sensor 30, AD conversion is performed by the A/D converter 42 and fast Fourier transform (FFT) is performed by the frequency analyzing device 44. The resultant information is output to the control unit 4.

The control unit 4 includes a control device 50 and a vibration processing device 52. A display device 54 is connected to the control unit 4. The display device 54 is a touch panel provided on a console, and displays a screen indicating a control state of the machine tool 1 and an operation screen to be operated by an operator.

The vibration processing device 52 receives information indicating a control state from the control device 50, and outputs a control instruction in response to an operation input by the operator to the control device 50. The vibration processing device 52 performs predetermined processing related to a chatter vibration on the basis of a signal received from the signal processing device 40 and a signal received from the control device 50.

The vibration processing device 52 causes a screen (a status screen) indicating a vibration state of the spindle 18 (that is, a vibration state of the tool T) to be displayed on the basis of a signal input from the signal processing device 40, and determines whether a chatter vibration has occurred. Upon determining that a chatter vibration has occurred, the vibration processing device 52 causes an operation screen (a tuning screen) for causing the chatter vibration to converge to be displayed. These processes will be described later in detail.

The control device 50 controls an actuator, such as a motor, in accordance with a machining program (an NC program) created manually or automatically. For turning of a workpiece W, the control device 50 drives a servomotor via a driving circuit 56 to feed-drive the spindle head 14. The control device 50 also drives a spindle motor via the driving circuit 56 to rotate the spindle 18.

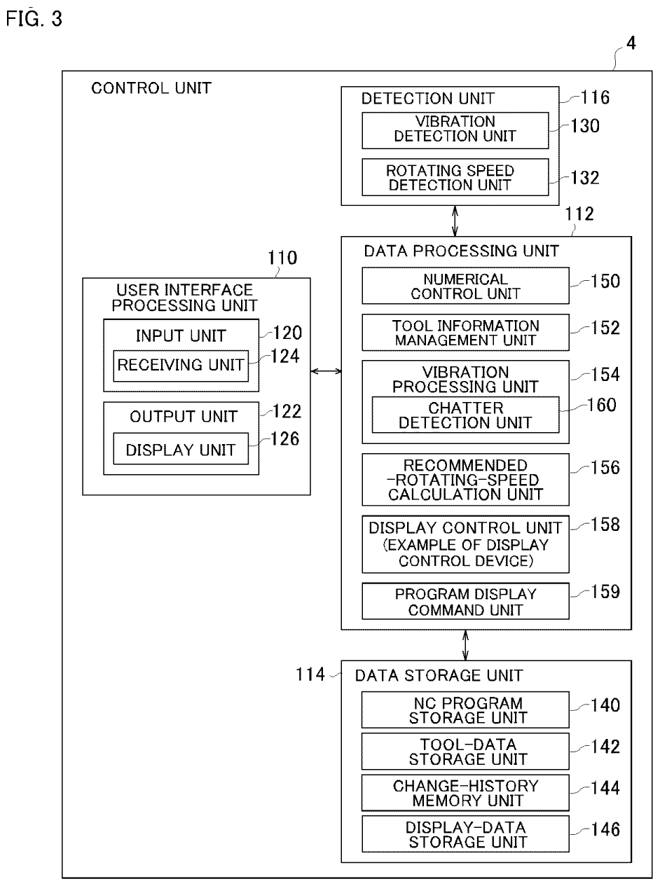

FIG. 3 is a functional block diagram of the control unit 4.

The components of the control unit 4 are implemented by hardware including computing units such as central processing units (CPUs) and various computer processors, storage devices such as memories and storages, and wired or wireless com-munication lines that connect these units and devices, and software that is stored in the storage devices and supplies processing instructions to the computing units. Computer programs may be constituted by device drivers, operating systems, various application programs on upper layers thereof, and a library that provides common functions to these programs. Blocks to be described below do not refer to configurations in units of hardware but to blocks in units of functions.

The control unit 4 includes a user interface processing unit 110, a data processing unit 112, a data storage unit 114, and a detection unit 116. The user interface processing unit 110 performs processes related to user interfaces such as receiving op-crations input by an operator, displaying images, and outputting audio. The data processing unit 112 performs various processes on the basis of data obtained by the user interface processing unit 110, information (detected values) detected by the detection unit 116, and data stored in the data storage unit 114. The data processing unit 112 also functions as an interface of the user interface processing unit 110, the detection unit 116, and the data storage unit 114. The data storage unit 114 stores various programs and set data therein.

The user interface processing unit 110 includes an input unit 120 and an output unit 122. The input unit 120 receives input made by the operator via a touch panel or a hardware device such as a handle. The input unit 120 includes a receiving unit 124. The receiving unit 124 receives a change instruction from the operator, such as an instruction to change a rotating speed or a feed speed of the spindle 18.

The output unit 122 provides the operator with various kinds of information by image display or audio output. The output unit 122 includes a display unit 126. The display unit 126 may cause a panel (a keyboard and a machine operation panel) to be displayed as an operation screen on the display device 54. The display unit 126 displays a status screen indicating a state (a control state and a vibration state) of the spindle 18 and, when a chatter vibration has occurred, displays the above-described tuning screen (described later in detail).

The detection unit 116 includes a vibration detection unit 130 and a rotating speed detection unit 132. The vibration detection unit 130 detects a vibration of the spindle 18 (that is, a vibration of the tool T) on the basis of a sensor output from the acceleration sensor 30, and acquires information output from the signal processing device 40. The rotating speed detection unit 132 detects the rotating speed of the spindle 18 (that is, the rotating speed of the tool T) on the basis of a sensor output of a rotary encoder (not illustrated) attached to the spindle 18.

The data storage unit 114 includes an NC program storage unit 140, a tool-data storage unit 142, a change-history memory unit 144, and a display-data storage unit 146. The NC program storage unit 140 stores a machining program (an NC program) therein. The tool-data storage unit 142 stores therein information on the tool T to be used in the machine tool 1 (tool information) in association with a tool ID. The tool information includes such information as a tool type, a tool diameter, and the number of cutting edges. A range in which the spindle rotating speed can be adjusted by the vibration processing device 52 (hereinafter, referred to as an “adjustable range”) is also associated with the tool information.

The change-history memory unit 144 stores history of operations performed by the operator to make chatter vibrations converge. Specifically, when an instruction to change the rotating speed or the feed rate of a tool entered by the operator is received during execution of a machining program, information on the block number of the machining program being executed (the line of the program) and a change corresponding to the change instruction are stored in association with each other (details will be described later). The display-data storage unit 146 stores screen data to be displayed on the display unit 126, and various image data, such as softkeys and dialog boxes, to be displayed within a screen.

The data processing unit 112 includes a numerical control unit 150, a tool information management unit 152, a vibration processing unit 154, a recommended-rotating-speed calculation unit 156, a display control unit 158, and a program display command unit 159. The numerical control unit 150 includes the functions of the control device 50. The numerical control unit 150 controls the machining equipment 2 on the basis of a command input from the input unit 120 in accordance with a machining program stored in the data storage unit 114.

The numerical control unit 150 also sequentially transmits information indicating a current state of control performed by the control device 50 (control information) to the vibration processing unit 154. The numerical control unit 150 transmits a control command value of the spindle rotating speed (hereinafter, also referred to as a “control-command spindle rotating speed”), for example.

The tool information management unit 152 manages information on each tool T (tool information) stored in the tool-data storage unit 142 in association with a tool ID.

The vibration processing unit 154 includes a chatter detection unit 160 as a function of the vibration processing device 52. The frequency analyzing device 44 described above receives a signal continuously output from the acceleration sensor 30 and analyzes the signal by Fourier analysis (frequency analysis) at a predetermined sampling interval, thereby calculating a frequency of a vibration occurring at the tool T (referred to as a “vibration frequency”) and the magnitude of that vibration (also referred to as a “vibration level”). The chatter detection unit 160 acquires information including the vibration level and the vibration frequency and, when the vibration level has exceeded a predetermined threshold, determines that a chatter vibration has occurred.

Although an example of a configuration in which the frequency analyzing device 44 is included in the signal processing device 40 (see FIG. 2) and is separate from the control unit 4 has been described in the present embodiment, the functions of the frequency analyzing device 44 may be included in the vibration processing unit 154 as a “frequency analysis unit” in a modification. Furthermore, the signal processing device 40 may be included in the control unit 4 as a part thereof.

When a chatter vibration has occurred, the recommended-rotating-speed calculation unit 156 calculates a preferable speed to which the spindle rotating speed is to be changed (also referred to as a “recommended rotating speed”) in order to cause this chatter vibration to converge. The recommended rotating speed can be calculated by a method described in JP 2018-176296 A, for example.

Specifically, when a detected chatter vibration is regenerative chatter, a recommended rotating speed SS (a recommendation value) can be calculated by the following Expression (1) on the basis of a vibration frequency ω0 (a chatter frequency) at that time and the number n of cutting edges of the tool T.

SS=(60×ω0)/(n×k) (1)
where k is a given integer equal to or greater than 1.

The recommended rotating speed SS is a rotating speed corresponding to the k-th order stability pocket in a stability limit diagram. A chatter vibration may be able to be eliminated by adjusting the spindle rotating speed to the recommended rotating speed SS. When the recommended rotating speed SS that is obtained by Expression (1) described above when k is set to 2, for example, with respect to the spindle rotating speed S0 at which the chatter vibration has occurred is within a stability region, the chatter vibration can be eliminated by changing the spindle rotating speed from S0 to SS.

The number n of cutting edges of the tool T can be acquired on the basis of the tool ID of the tool T being currently used. The tool information management unit 152 refers to the tool-data storage unit 142 on the basis of that tool ID and acquires the number n of cutting edges. The recommended-rotating-speed calculation unit 156 calculates a first recommendation value higher than a current control-command spindle rotating speed and a second recommendation value lower than the current control-command spindle rotating speed as recommended rotating speeds to be presented to the operator.

The display control unit 158 controls display of the display unit 126. The display control unit 158 causes the display unit 126 to display a screen indicating a state of control performed by the control device 50 (a status screen and the like), and a screen for monitoring occurrence of a chatter vibration (a tuning screen and the like). When a selection of a change command made by the operator is received, the display control unit 158 also displays the change on the screen (details will be described later).

Upon an instruction to apply the change, which will be described later, is input by the operator, the program display command unit 159 performs a program updating process of reflecting the change in the machining program (details will be described later).

The vibration processing unit 154, the recommended-rotating-speed calculation unit 156, the display control unit 158, the receiving unit 124, and the display unit 126 function as a “display control device” that controls the operating state of the machine tool 1.

Next, processing involved in detecting occurrence of a chatter vibration and suppressing the chatter vibration will be specifically described.

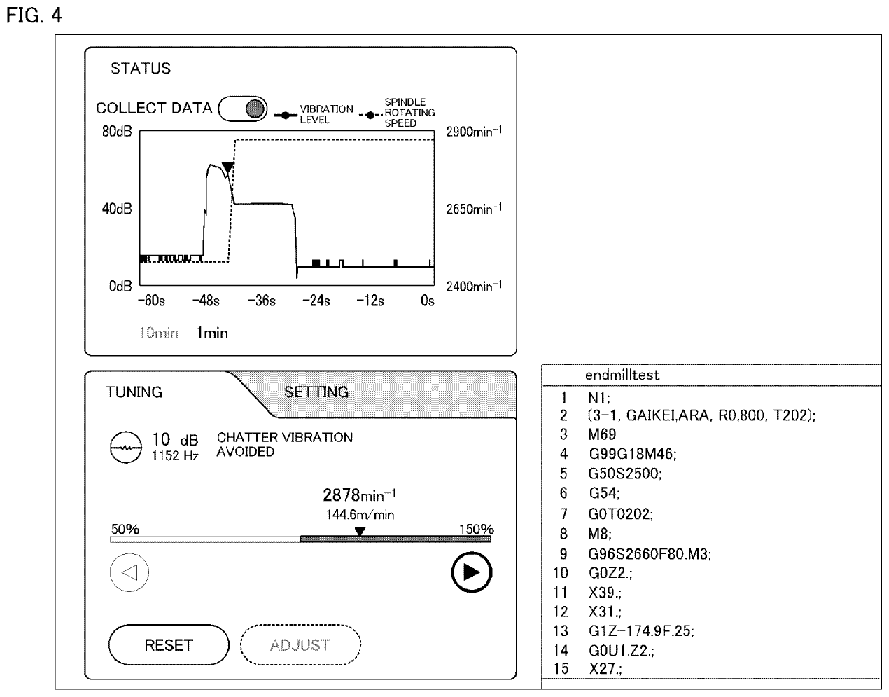

FIG. 4 is a diagram illustrating a management screen for managing a state of control performed by the control device 50.

A running NC program is displayed in a lower right region on this management screen. A status screen is displayed in an upper left region thereon. A tuning screen is displayed in a lower left region thereon. Data stored in the display-data storage unit 146 are used for these displays.

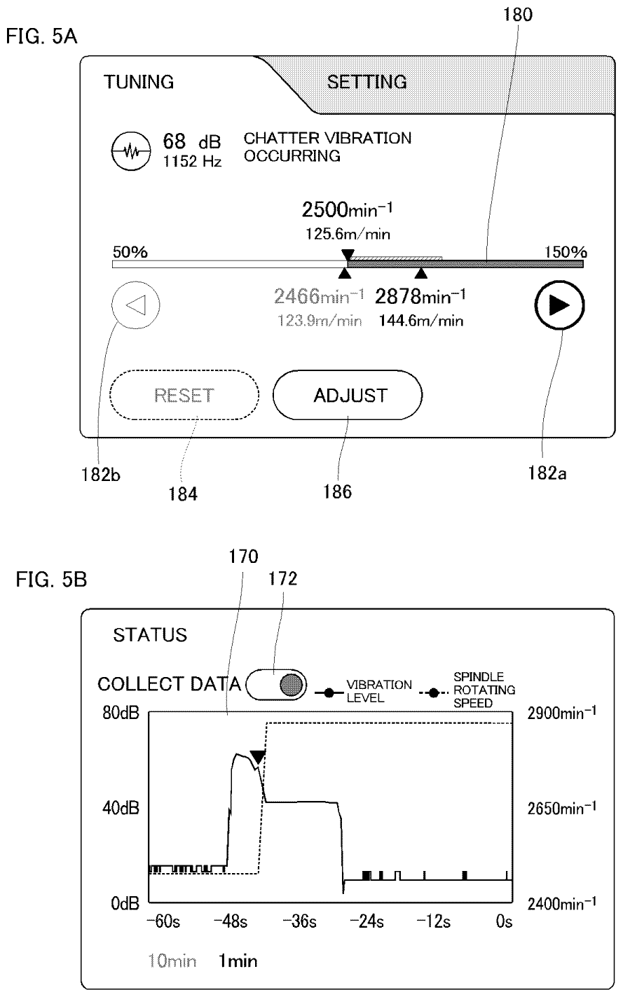

FIGS. 5A and 5B are diagrams illustrating a tuning screen and a status screen. FIG. 5A illustrates an example of the tuning screen, and FIG. 5B illustrates an example of the status screen.

As illustrated in FIG. 5A, an override bar 180 for indicating a spindle rotating speed is displayed in a central region on the tuning screen. The override bar 180 is a scale object (an object having a scale function) extending in the left-right direction on the screen. The center of the override bar 180 indicates a position at which a program-command spindle rotating speed is 100%. Note that the “program-command spindle rotating speed” is a spindle rotating speed specified by a machining program. The program-command spindle rotating speed does not change until a new value is commanded on the program. A current control-command spindle rotating speed (2500 min⁻¹ in the illustrated example) is displayed above the override bar 180. The control-command spindle rotating speed is a spindle rotating speed commanded by a PLC.

At start of the tuning screen, the control-command spindle rotating speed is displayed above the center of the override bar 180 because the program-command spindle rotating speed and the control-command spindle rotating speed are equal to each other. When the spindle rotating speed is changed by the vibration processing device 52, the display position of the control-command spindle rotating speed is changed depending on a ratio of the change. While normal control is performed, an actual spindle rotating speed detected by the above-described rotary encoder (also referred to as an “actual spindle rotating speed”) is substantially equal to the control-command spindle rotating speed.

The right end of the override bar 180 is a position indicating 150% (that is, +50%) of the program-command spindle rotating speed, and the left end thereof is a position indicating 50% (that is, −50%) of the program-command spindle rotating speed. That is, the override bar 180 corresponds to a “ratio display unit” that indicates a ratio of a change in the control-command spindle rotating speed to the current program-command spindle rotating speed.

A vibration level and a peak frequency currently detected are displayed in an upper region on the tuning screen. The “peak frequency” means a vibration frequency at which the vibration level is currently the highest. In the illustrated example, a vibration level of 68 (dB) and a peak frequency of 1152 (Hz) are displayed. Furthermore, because a chatter vibration has been determined as having occurred on the basis of this vibration level, a text “chatter vibration occurring” that is notification of the occurrence is displayed.

When a chatter vibration has been detected, the recommended-rotating-speed calculation unit 156 calculates two recommended rotating speeds for causing the chatter vibration to converge (the first recommendation value and the second recommendation value) as described above. The display control unit 158 causes the calculated two recommendation values to be displayed on the tuning screen. In the illustrated example, “2878 min⁻¹” and “2466 min⁻¹” are displayed as the first recommendation value and the second recommendation value, respectively, below and along the scale.

Symbol ▾ indicating a position of the control-command spindle rotating speed and its numerical value (2500 min⁻¹) are displayed at a position corresponding to the ratio of the control-command spindle rotating speed to the program-command spindle rotating speed on the override bar 180. Symbol ▴ indicating a position of the first recommendation value and its numerical value (2878 min⁻¹) are displayed at a position corresponding to the ratio of the first recommendation value to the program-command spindle rotating speed in the override bar 180. Similarly, symbol ▴ indicating a position of the second recommendation value and its numerical value (2466 min⁻¹) are displayed at a position corresponding to a ratio of the second recommendation value to the program-command spindle rotating speed on the override bar 180.

A numerical value (m/min) under each spindle rotating speed represents the peripheral speed (m/min) of a tool and is calculated by the following Expression (2).

Peripheral speed[m/min]=spindle rotating speed[min⁻¹]×π×(tool diameter [mm]/1000) (2)

This “peripheral speed” is an index of a tool load.

As will be described later, however, because one of the first and second recommendation values is set to be selectable by presetting performed by the operator as described later, the other recommendation value that is not selectable is grayed out. The presetting of the recommendation value can be performed by switching between select buttons 182a and 182b that will be described later. Detailed description of the switching is omitted.

The tuning screen is an operation screen having a touch panel function, on which a plurality of kinds of buttons selectable by the operator are displayed. The select buttons 182a and 182b for selecting a method of setting the recommendation values are displayed a little below the right and left ends, respectively, of the override bar 180. A reset button 184 and an adjust button 186 are displayed in a lower region on the tuning screen. The adjust button 186 serves as an “instruction input unit” that receives a speed change command for the spindle rotating speed. The reset button 184 serves as a “reset command input unit” that receives a command to reset the control-command spindle rotating speed to the program-command spindle rotating speed.

Note that whether or not each of the reset button 184 and the adjust button 186 is selectable is determined during processing performed by the vibration processing unit 154. When a button is selectable, the button is displayed in a normal manner (also referred to as “displayed as being active”). When a button is not selectable, the button is grayed out. The adjust button 186 is displayed as being active when the selected recommendation value is within a preset adjustable range.

In the illustrated example, the first recommendation value is selected in the presetting, and the select button 182a is displayed as being active. Since a chatter vibration has occurred in this state, the second recommendation value is grayed out. In addition, since the selected first recommendation value is within the adjustable range, the adjust button 186 is displayed as being active. The operator can give an instruction to change the control-command spindle rotating speed (2500 min⁻¹) to the recommended rotating speed (the first recommendation value: 2878 min⁻¹) by tapping (selecting) the adjust button 186 in this state.

In the present embodiment, the adjustable range of the spindle rotating speed is set to a range from 50% to 150% (that is, within +50%) of the program-command spindle rotating speed, as illustrated in FIG. 5A. This setting prevents a sudden change of the rotating speed (the control state) of the spindle 18 which is unexpected for the operator.

The vibration processing unit 154 outputs an instruction to change the spindle rotating speed to the numerical control unit 150 in response to an input made by the operator. In response to this change instruction, the numerical control unit 150 changes the control command value of the spindle rotating speed (that is, the control-command spindle rotating speed).

The status screen in FIG. 5B illustrates an example of a result of changing the control-command spindle rotating speed in accordance with the recommended rotating speed presented on the tuning screen in FIG. 5A. This status screen is a default status screen (a first status screen). A sampling screen 170 is displayed at the center on the status screen, in which the horizontal axis represents elapsed time and the vertical axis represents the vibration level and the spindle rotating speed. The sampling screen 170 is a real-time chart that displays the change in the vibration level and the change in the spindle rotating speed in real time. A solid line represents the change in the vibration level (dB), and a dotted line represents the change in the control-command spindle rotating speed (min⁻¹). Symbol ▾ in the chart is a marker indicating a timing of switching of the control-command spindle rotating speed in accordance with an operation (a change instruction) input by an operator.

This status screen is also an operation screen having a touch panel function and allows selection of either a pattern in which the scale of the horizontal axis in the sampling screen 170 is up to 10 min or a pattern in which that scale is up to 1 min (60 s). The latter pattern is selected in the illustrated example. A current time is indicated as “0 s” at the right end of the screen. A previous sampling history is continuously displayed on the left side thereof. The sampling screen 170 is displayed in real time by turning on a collect data button 172 at an upper left position on the screen.

The display control unit 158 controls display of time-series data indicating the changes in the detected values detected by the detection unit 116, that is, the change in the vibration level detected by the vibration detection unit 130 and the change in the spindle rotating speed (that is, the rotating speed of the tool T) as this status screen.

Upon receiving the instruction to change the spindle rotating speed made by an operation input by the operator, the display control unit 158 displays the marker ▾ indicating the timing of the change instruction on the time-series data in a superimposing manner.

In the illustrated example, machining corresponding to a predetermined block has started at a control-command spindle rotating speed of 2500 min⁻¹ after an idling state of a machine tool at about 48 seconds before the current time. Immediately after the start, a chatter vibration has occurred, and therefore the vibration level has rapidly increased up to about 60 dB. Therefore, the control-command spindle rotating speed has been changed from 2500 min⁻¹ to about 2878 min⁻¹ by an operation made by the operator in accordance with the presentation on the tuning screen at about 45 seconds before the current time. As a result, the chatter vibration has converged at about 40 seconds before the current time, and machining has been continued in a state where the vibration level has reduced to about 40 dB. Machining corresponding to that block has ended about 26 seconds before the current time.

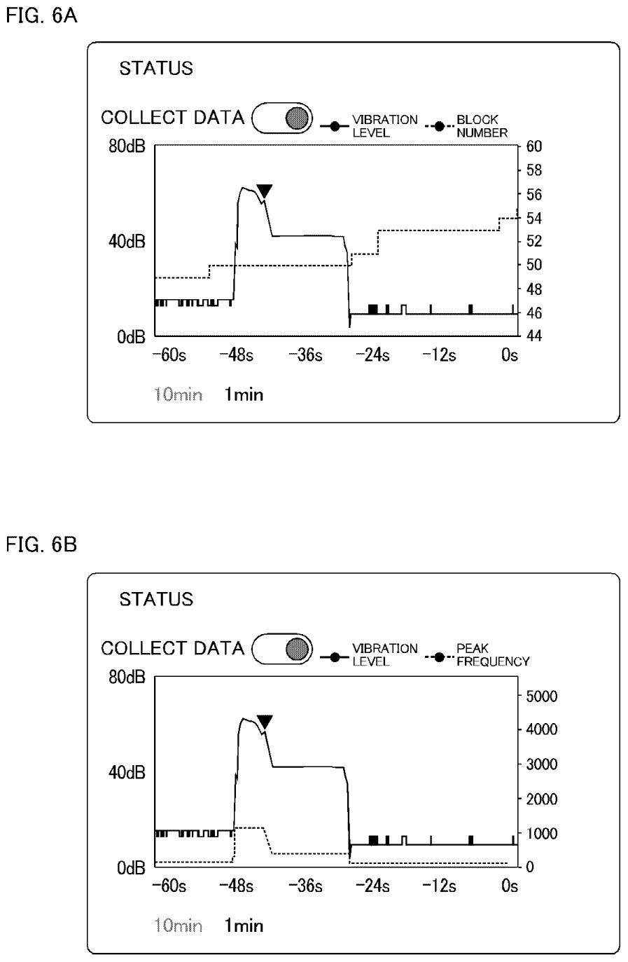

FIGS. 6A and 6B are diagrams illustrating status screens after screen switching.

FIGS. 6A and 6B illustrate a second status screen and a third status screen, respectively.

A dotted line in FIG. 6A represents the block number of a machining program. The operator can switch the screen in FIG. 5B to the second status screen in FIG. 6A by using a setting screen (not illustrated). The display control unit 158 causes the block number, which is a parameter other than the command spindle rotating speed, to be displayed as time-series data in response to a selection instruction made by an operation input by the operator.

The second status screen shows a block in which a chatter vibration has occurred and a control-command spindle rotating speed has been switched by the operator. In the illustrated example, it is shown that chatter vibration has occurred and an operation has been input by the operator in the 50th block of the machining program.

Although the control-command spindle rotating speed itself displayed on the first status screen is not displayed on this second status screen, the display of the change instruction timing of the control-command spindle rotating speed (the marker ▾) remains on the second status screen. The second status screen therefore clearly shows the block in which the control-command spindle rotating speed has been switched by the operator.

A dotted line in FIG. 6B indicates the peak frequency in chronological order. The “peak frequency” means a vibration frequency that provides the highest vibration level at each time point. The peak frequency at the time of occurrence of a chatter vibration therefore represents the frequency of the chatter vibration itself (also referred to as “chatter frequency”).

The operator can switch the screen in FIG. 5B or FIG. 6A to the third status screen in FIG. 6B by using a setting screen (not illustrated), such as a pulldown menu. The display control unit 158 displays the peak frequency, which is still another parameter, as time-series data in response to a selection instruction made by an operation input by the operator.

The third status screen shows a peak frequency immediately before the control-command spindle rotating speed has been switched by the operator after a chatter vibration has occurred, that is, the frequency as a factor of the chatter vibration. In the illustrated example, it can be seen that the chatter frequency is about 1200 Hz.

Although the control-command spindle rotating speed itself displayed on the first status screen is not displayed on this third status screen either, the display of the change instruction timing of the control-command spindle rotating speed (the marker ▾) remains on the third status screen. The third status screen therefore shows the peak frequency immediately before switching of the control-command spindle rotating speed by the operator, that is, the peak frequency while the chatter vibration occurs.

The vibration level, the control-command spindle rotating speed, the change instruction timing (the marker), and the time-series data including the block number and the peak frequency, which are displayed on the first to third status screens described above, are stored as control history data in the data storage unit 114. The operator can therefore check each status screen afterwards. These status screens function as control history screens indicating the change in the control state detected by the detection unit 116, the change in the control state based on the machining program, and the like as time-series data.

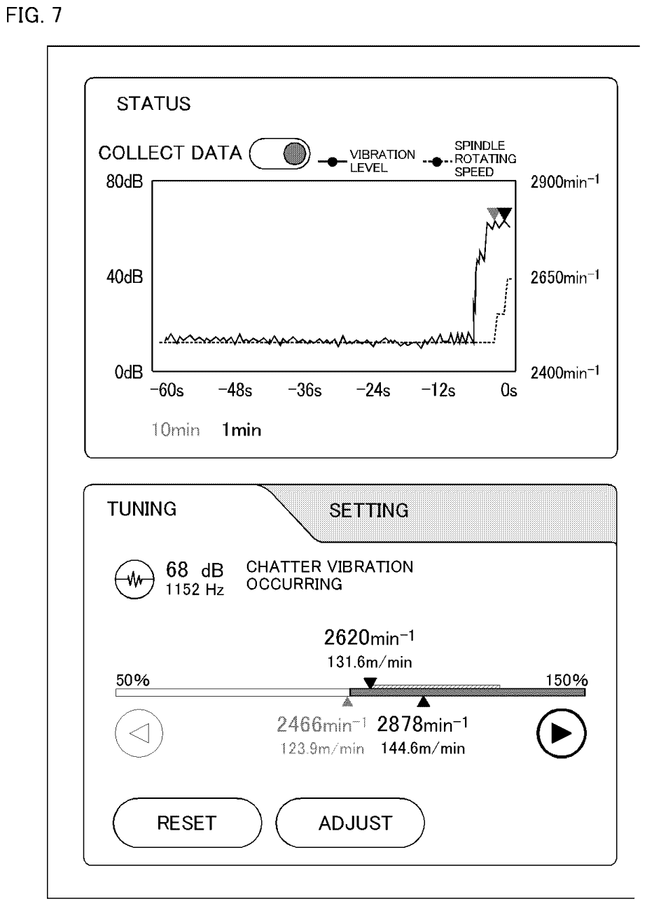

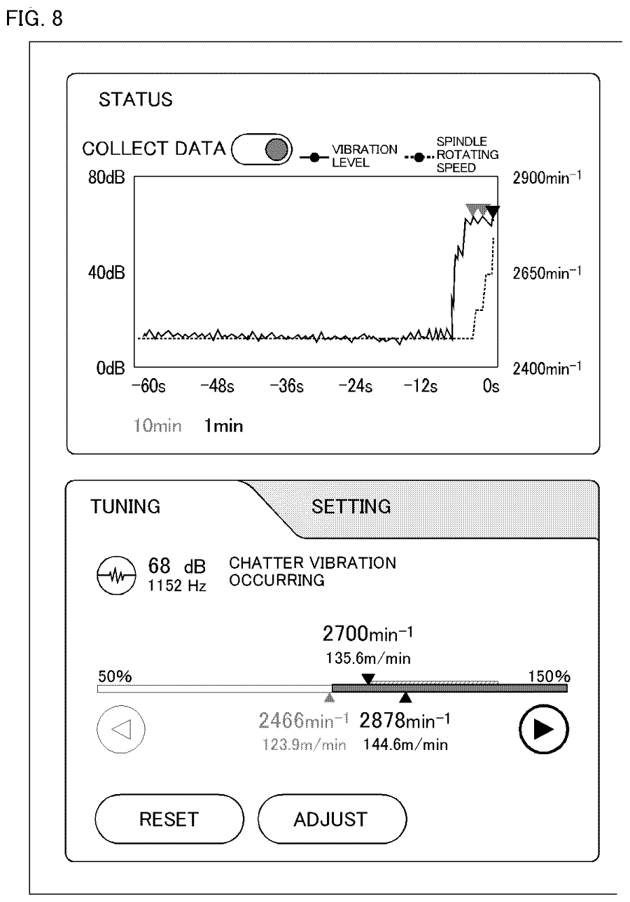

FIGS. 7 and 8 are diagrams illustrating examples of screens that can be displayed in a vibration control process.

In this example, as illustrated in FIG. 7, after adjustment of the control-command spindle rotating speed by the operator has been performed twice, two markers ▾ each indicating a change timing are displayed as being superimposed on time-series data on a status screen. Since the chatter vibration has not converged as a result of the adjustment performed twice, third presentation of a recommended rotating speed is made on a tuning screen.

The operator has changed the control-command spindle rotating speed in accordance with the third presentation. As a result, as illustrated in FIG. 8, three markers ▾ each indicating the change timing are displayed as being superimposed on the time-series data on the status screen. Since the chatter vibration has not converged as a result of the adjustment performed three times, fourth presentation of the recommended rotating speed is made on the tuning screen.

As described above, when switching of the control-command spindle rotating speed is performed multiple times, the recommended rotating speed presented on the tuning screen is changed each time the control-command spindle rotating speed is switched. The change in the vibration level resulting from an operation input by the operator and the change history of the control-command spindle rotating speed are updated on the status screen from moment to moment.

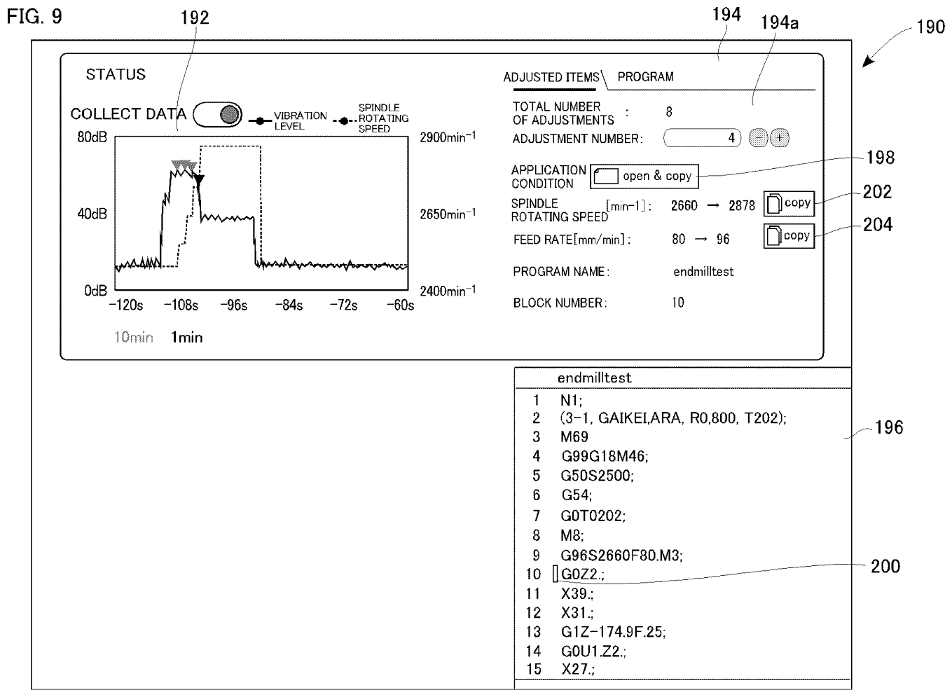

FIG. 9 is a diagram illustrating a change history check screen that can be referred to by an operator afterwards.

The change history of control amounts for suppressing chatter vibrations described above can be checked afterwards by referring to the status screen, but the changes are not automatically reflected in the machining program. A program can be rewritten on the basis of a change instruction made by the operator via a change history check screen 190 described below.

The display control unit 158 displays the change history check screen 190 indicating previous operations (that is, history of change instructions) that have contributed to suppression of a chatter vibration in response to an operation input by the operator. The change history check screen 190 includes a control history screen 192 and an operation screen 194 in an upper part thereof. The change history check screen 190 can be displayed together with a program screen 196 on the display device 54. The control history screen 192 and the operation screen 194 constitute a fourth status screen. In a modification, the program screen 196 may be provided as a screen independent of the operation screen 194.

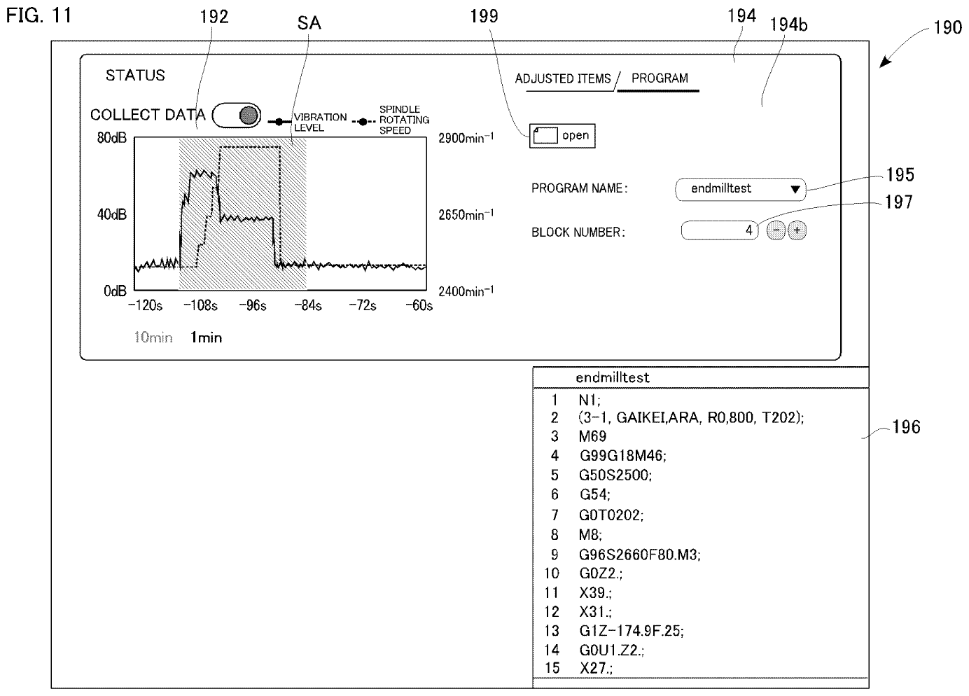

The operation screen 194 includes an adjusted item check screen 194a and a program check screen 194b (see FIG. 11), which are switched therebetween by selecting either of tubs at upper positions on the screen. When an adjusted item tab is selected, the adjusted item check screen 194a is displayed. The adjusted item check screen 194a also functions as a “change application screen” for reflecting a change corresponding to a change instruction made by the operator in the machining program.

The control history screen 192 displays the history of the sampling screen 170 (see FIG. 5B). The adjusted item check screen 194a shows changes in machining condition as numerical values. In the illustrated example, the control-command spindle rotating speed has been adjusted eight times by the operator, and markers ▾ indicating control history screen 192 are displayed as being superimposed on time-series data. Although four markers ▾ are displayed on the illustrated screen, four more markers ▾ are present outside the screen (in regions of shifted time frame).

The adjusted item check screen 194a displays a total number of adjustments, an adjustment number, a condition of application, a change in the spindle rotating speed, a change in the feed rate, a program name, and a program line (block number). The “total number of adjustments” indicates the number of times the control command value has been changed for convergence of a chatter vibration. The “adjustment number” is the number of the adjustment that the operator is checking, which can be freely selected when the spindle rotating speed has been changed a plurality of timer of times. A number corresponding to any one of the first to eighth adjustments indicated by the eight markers ▾ can be input.

The display control unit 158 displays the markers as input objects for receiving a selection input by the operator and, when any one marker is selected, displays changes associated with the selected marker as the adjusted item check screen 194a. The operator may directly input an adjustment number, or specify a marker by increasing or decreasing the adjustment number by using a + button or a − button. In this example, an adjustment number of 4 is selected, the corresponding marker is therefore displayed as being active, and the other markers are grayed out.

As a result, the display indicates that the fourth adjustment include a change in the control-command spindle rotating speed from 2660 min 1 to 2878 min⁻¹ and a change in the feed rate from 80 mm/min to 96 mm/min, that the changes are made during a block number 10, and the like.

In the illustrated example, a chatter vibration has not converged as a result of the first to third adjustments, and has temporarily converged as a result of this fourth adjustment. Thus, when the number 4 is specified as the adjustment number, the command spindle rotating speed and the feed rate at which the chatter vibration has converged can be checked. Display of the change history check screen 190 in this manner after machining allows the machining condition applied upon occurrence of a chatter vibration and the change of the vibration to be clearly checked as numerical values afterwards.

The program screen 196 is a versatile screen for selecting a program to be executed and editing a program. The operator can freely edit a program on the program screen 196.

The adjusted item check screen 194a displays an open & copy button 198 as the application condition. When the operator taps the open & copy button 198, the following operations are performed. Note that FIG. 9 illustrates a state before application of the change history to the machining program.
(1) Program information (a machining condition) associated with the selected adjustment number is copied to the clipboard.
(2) The machining program that was being executed at the time of adjustment is called onto the program screen 196.
(3) A cursor 200 is displayed at the position of the block that was being executed at the time of adjustment.

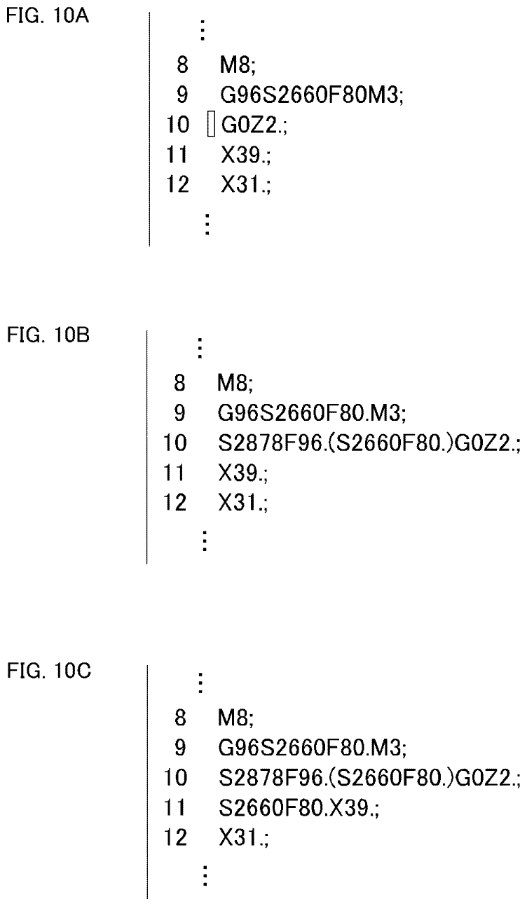

FIGS. 10A to 10C illustrate an example of a process of updating a machining program. FIGS. 10A to 10C each illustrate a part of the machining program, which is processing in the updating process.

As described above, the cursor 200 is displayed at the position of a block number to be changed on the program screen 196 (FIG. 10A). The illustrated state is before the program is updated. At block number “9” immediately before a block number “10” associated with the adjustment number selected on the adjusted item check screen 194a, “G96 S2660 F80 M3” is written. Here, S2660 is set as an S code specifying the spindle rotating speed, and F80 is set as an F code specifying the feed rate. As a result, a chatter vibration has occurred during execution of the block number “10”.

In this regard, the previous change history (FIG. 9) shows that the operator has changed the spindle rotating speed from 2660 min⁻¹ to 2878 min⁻¹, and the feed rate from 80 mm/min to 96 mm/min, thereby the chatter vibration has converged. Thus, when the operator taps the open & copy button 198 as described above, “S2878 F96. (S2660 F80.)” for the block number “10” of the machining program is copied to the clipboard. As a result, the operator can insert the machining condition only by pasting, thereby changing the S code and the F code (FIG. 10B).

In “S2878 F96. (S2660 F80.)”, “S2878 F96.” indicates the code to be updated this time, and “S2660 F80.” in parentheses indicates the code of the original program before the update as being commented out for reference.

Because the chatter vibration may have occurred only in relation to “GOZ2” in the original program, “S2878 F96.” is inserted to the next block number “11” to restore the S code and the F code (FIG. 10C). Although the codes are restored to the original codes at the next block in this manner in the present embodiment, the codes may be set not to be restored in a modification.

The description refers back to FIG. 9, in which a copy button 202 is displayed next to the display of the spindle rotating speed, and a copy button 204 is displayed next to the display of the feed rate. These buttons are selected when the change in the spindle rotating speed and the change in the feed rate are to be individually copied to the clipboard. Thus, the conditions of both of the spindle rotating speed and the feed rate are copied to the clipboard when the aforementioned open & copy button 198 is selected, whereas the copy button 202 can be selected to copy only the spindle rotating speed to the clipboard and the copy button 204 can be selected to copy only the feed rate to the clipboard.

Specifically, when the copy button 202 is selected, “S2878 (S2660)” is copied to a corresponding block number. When the copy button 204 is selected, “F96. (F80.)” is copied to a corresponding block number.

FIG. 11 is a diagram illustrating a state in which the program check screen 194b is displayed.

When the program tab is selected, the program check screen 194b is displayed. The program check screen 194b includes a program selection part 195 and a block selection part 197. The program selection part 195 allows any one of a plurality of machining programs to be selected using a pull-down menu. The operator can select a machining program to be checked from the menu.

The block selection part 197 receives specification of a block number in the machining program selected in the program selection part 195. The operator can perform the specification by increasing or decreasing the block number by using a + button or a − button. The display control unit 158 displays, on the control history screen 192, execution history of the machining program selected on the program check screen 194b.

The control history screen 192 includes display for visually identifying a region corresponding to the specified block number (see hatching in FIG. 11; hereinafter also referred to as “region identifying display”). The region identifying display SA may be highlighting. The display control unit 158 displays the region identifying display SA as being superimposed on a region corresponding to the block number in display of time-series data. The program screen 196 displays the block number selected on the program check screen 194b and the machining program including blocks of the selected block number and block numbers before and after the selected block number.

When the operator specifies a program name and a block number on the program check screen 194b, the region identifying display SA is provided in this manner, which allows the operator to intuitively grasp the relation between the machining program and the control state (including effects on the chatter vibration). In addition, history including previous change instructions, previous changes, changes in the control state resulting from the previous changes, and the like can be freely checked.

Conversely, when the operator specifies a region by touching part of the region on the control history screen 192, the program name and the block number associated with the region are displayed in the program selection part 195 and the block selection part 197, respectively. This allows the operator to check the control history screen 192 and specify a region in which a chatter vibration has converged, for example, thereby the block number of the machining program corresponding to the cause of the chatter vibration can be identified.

An open button 199 is provided on an upper part of the program check screen 194b. When the open button 199 is selected, the machining program specified in the program selection part 195 and the block selection part 197 is displayed on the program screen 196. Specifically, the machining program including blocks of the selected block number and block numbers before and after the selected block number is displayed on the program screen 196.

Next, specific processing for suppressing a chatter vibration is described.

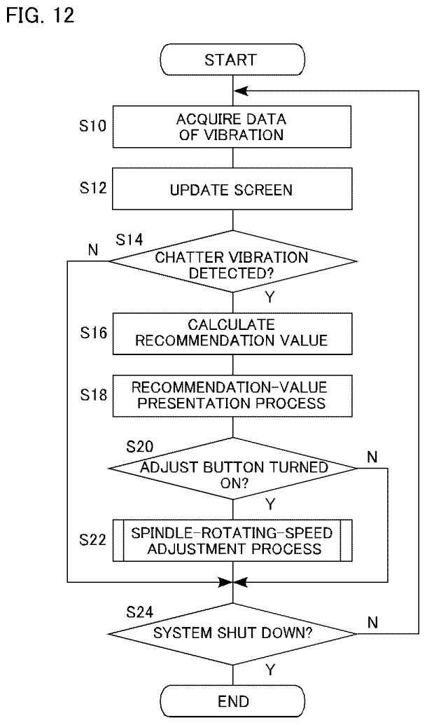

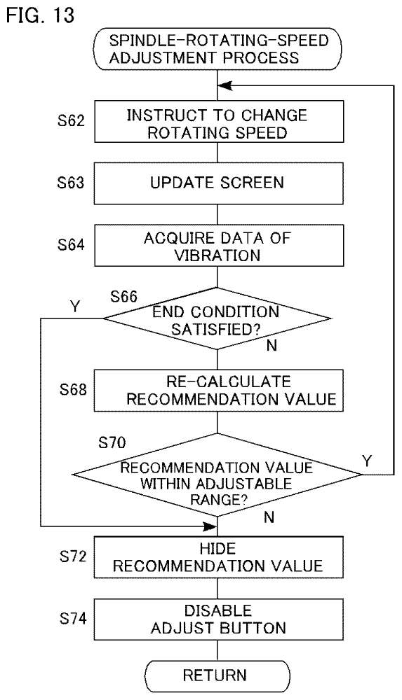

FIG. 12 is a flowchart of a vibration control process. FIG. 13 is a flowchart of a spindle-rotating-speed adjustment process in S22 in FIG. 12.

As illustrated in FIG. 12, in the vibration control process, the vibration processing unit 154 acquires data of a vibration of the spindle 18 via the detection unit 116 (S10). The display control unit 158 updates a status screen and a tuning screen on the basis of the vibration data (S12).

The status screen and the tuning screen are displayed also while no chatter vibration occurs. When a vibration level exceeds a threshold and the chatter detection unit 160 detects a chatter vibration (Y in S14), the recommended-rotating-speed calculation unit 156 calculates a recommended rotating speed (S16). A recommendation-value presentation process is then performed (S18).

In this recommendation-value presentation process, when both of the calculated first and second recommendation values are within an adjustable range (within ±50% of the program-command spindle rotating speed in the present embodiment), the display control unit 158 causes both of the recommendation values to be displayed (see FIG. 5A). In this case, the operator taps (selects) the adjust button 186 to change the control-command spindle rotating speed to the first recommendation value.

When only the selected one of the recommendation values (a selected recommendation value) is within the adjustable range, the display control unit 158 causes only the selected recommendation value to be displayed and enables the adjust button 186. In this case as well, the operator taps the adjust button 186 to change the control-command spindle rotating speed to the first recommendation value.

When only a non-selected one of the recommendation values (a non-selected recommendation value) is within the adjustable range, the display control unit 158 causes only the non-selected recommendation value to be displayed, but disables the adjust button 186. That is, the operator cannot change the spindle rotating speed in this state. When the selected recommendation value is changed by switching of the select buttons 182a and 182b, the spindle rotating speed can be changed.

When neither of the first and second recommendation values is within the adjustable range, the display control unit 158 hides both the recommendation values and disables the adjust button 186. In this state, the operator cannot change the spindle rotating speed.

When the adjust button 186 is tapped by an operation input by the operator (Y in S20), the spindle-rotating-speed adjustment process is performed (S22).

As illustrated in FIG. 13, in the spindle-rotating-speed adjustment process, the vibration processing unit 154 outputs an instruction to change to the selected recommended rotating speed (S62). The numerical control unit 150 changes the control-command spindle rotating speed to that recommended rotating speed and controls the spindle 18. The display control unit 158 updates the status screen and the tuning screen (S63). At this time, symbol ▾ indicating a timing of switching of the control-command spindle rotating speed is added on the status screen, and the display position of the control-command spindle rotating speed is updated on the tuning screen. Further, the reset button 184 is enabled, so that the operator can reset the control any time. The reset button 184 is enabled when the program-command spindle rotating speed and the control-command spindle rotating speed are different from each other.

The vibration processing unit 154 acquires data of a vibration of the spindle 18 via the detection unit 116 (S64). When a predetermined end condition has not been satisfied (N in S66) at this time, the recommended-rotating-speed calculation unit 156 re-calculates the recommended rotating speed (S68). Examples of this “end condition” set in the present embodiment are that a chatter vibration has converged, that a chatter vibration has become larger than that before adjustment, that the type of a chatter vibration has been changed, and that the frequency of a chatter vibration has been changed. In a modification, not all these conditions but any of them may be set as the end condition.

When the calculated recommendation value is within an adjustable range (Y in S70), the process returns to S62. When the end condition is then satisfied (Y in S66), the processes in S68 and S70 are skipped. The display control unit 158 hides the recommendation value (S72) and disables the adjust button 186 by graying it out (S74). Also when the calculated recommendation value is not within the adjustable range (N in S70), the display control unit 158 hides the recommendation value (S72), and grays out the adjust button 186 to disable it (S74).

The description refers back to FIG. 12, in which when the adjust button 186 is not tapped (N in S20), the process in S22 is skipped. When no chatter vibration is detected (N in S14), the processes in S16 to S22 are skipped. Thereafter, when the system is shut down, such as when the operation of the machine tool 1 is stopped (Y in S24), the series of processes are ended. When the system is not shut down (N in S24), the process returns to S10.

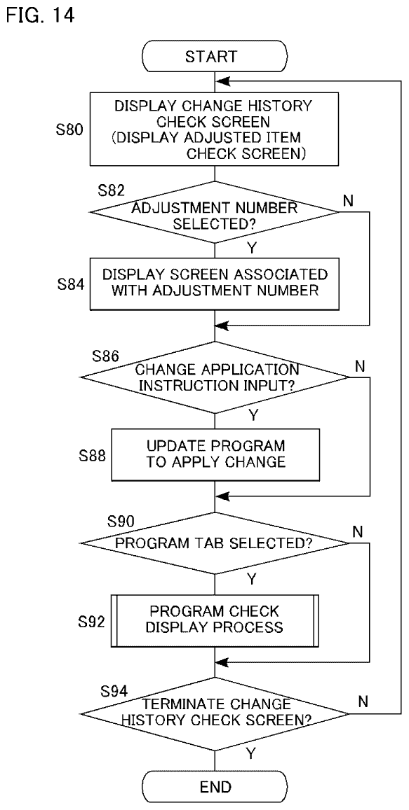

FIG. 14 is a flowchart of a change history check process.

When a change check button (not illustrated) is selected by the operator, the display control unit 158 causes the change history check screen 190 (see FIG. 9) to be displayed (S80). An initial screen of the change history check screen 190 displays the adjusted item check screen 194a as the operation screen 194.

When any adjustment number is selected by the operator in this state (Y in S82), the display control unit 158 displays a screen associated with the selected adjustment number (S84). Specifically, the control history screen 192 and the adjusted item check screen 194a including the change history associated with the adjustment number are displayed. In addition, the program screen 196 including the block number displayed on the adjusted item check screen 194a is displayed. When no adjustment number is selected (N in S82), the process in S84 is skipped.

When an instruction to apply a change based on the change history is input by the operator (Y in S86), the program display command unit 159 updates the machining program by applying the change (S88). Specifically, when the open & copy button 198, both of changes in the spindle rotating speed and the feed rate are applied. When the copy button 202 is selected, only a change in the spindle rotating speed is applied. When the copy button 204 is selected, only a change in the feed rate is applied. When no change application instruction is input (N in S86), the process in S88 is skipped.

When the program tab is selected (Y in S90), a program check display process is performed (S92). When the program tab is not selected (N in S90), the process in S92 is skipped.

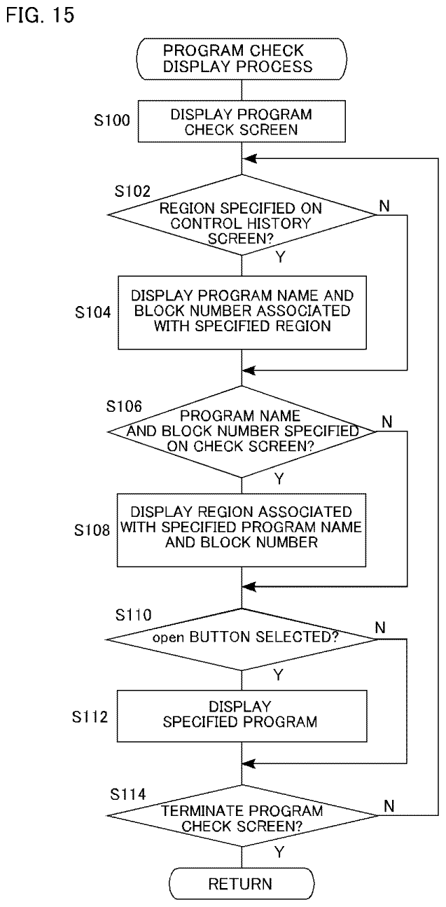

FIG. 15 is a flowchart of the program check display process in S92 in FIG. 14.

The display control unit 158 causes the program check screen 194b to be displayed (S100). When a region is specified by tapping of a part of the control history screen 192, for example (Y in S102), the display control unit 158 causes the program name and the block number associated with the specified region to be displayed on the program check screen 194b (S104). When no region is specified (N in S102), the process in S104 is skipped.

Conversely, when a program name and a block number are specified on the program check screen 194b (Y in S106), the display control unit 158 causes region identifying display SA to be displayed as being superimposed on a region associated with the program name and the block number on the control history screen 192 (S108). When no program name, etc., is specified (N in S106), the process in S108 is skipped.

When the open button 199 (Y in S110), the display control unit 158 causes the specified machining program to be displayed on the program screen 196 (S112). When the open button 199 is not selected (N in S110), the process in S112 is skipped. Thereafter, the processes in S102 to S112 are repeated until the program check screen 194b is terminated by being switched to the adjusted item check screen 194a, for example (N in S114).

The description refers back to FIG. 14, in which the processes in S80 to S92 are repeated until the change history check screen 190 is terminated by switching of the change history check screen 190 to another screen, for example (N in S94). When the change history check screen 190 is terminated (Y in S94), the present process is temporarily terminated.

The machine tool 1 has been described above on the basis of the embodiment.

According to the present embodiment, information for taking a measure against a chatter vibration, that is, a change in the spindle rotating speed and its change timing, a portion of a program corresponding to that change timing, and the like are automatically recorded on the machine tool 1 and displayed in a superimposing manner. This saves the operator the hassle during operation of the machine tool 1. Since the machine tool 1 always records time-series data, data including a change timing of the control-command spindle rotating speed, details of the change, the control state at the time of the change, and the like, can be presented to the operator in complete synchro-nization with each other.

Displaying a machining condition (the spindle rotating speed) as being superimposed on time-series data of the vibration level enables the operator to easily check the machining condition changed by oneself. Further, in a case where the spindle rotating speed has changed multiple times, a machining condition that is the most effective to suppress a chatter vibration can be easily checked.

Further, by displaying a point (a marker) of a change in the machining condition (the spindle rotating speed) and the peak frequency as being superimposed on the time-series data of the vibration level, a chatter frequency can be easily identified. A position at which the chatter vibration has occurred can also be identified by using the technology described in Patent Literature 1 in combination. Therefore, even in a case where the chatter vibration has not converged as a result of only changing the control-command spindle rotating speed, it can be easily determined which one of a tool, a tool holder, and a method of fixing a workpiece is to be changed.

Furthermore, a portion of a program can be easily identified by displaying the point (the marker) of the change the machining condition (the spindle rotating speed) and a block number of the program as being superimposed on the time-series data of the vibration level. In addition, a portion of a block at which a chatter vibration becomes especially large can be easily identified. Even when display of the spindle rotating speed is turned off, the display of the marker enables the change point to be easily seen.

In addition, when a chatter vibration has occurred, a recommended change value (a recommended rotating speed) of the control-command spindle rotating speed for causing the chatter vibration to converge is calculated in the machine tool internally, and the operator has only to determine whether to approve the recommendation. Therefore, the operator can easily take a quick response. Even an operator who is inex-perienced and does not have good intuition can take an action easily. The present embodiment can provide an operator-friendly display screen when an operation for suppressing a chatter vibration in the machine tool 1 is prompted.

Furthermore, a change history that has contributed to convergence of chatter vibrations can be checked on the change history check screen 190. The operator can casily check a vibration that has occurred at a certain block and the change history therefor by using the program check screen 194b. The operator can also easily check a position at which a large vibration has occurred and a block of a program corresponding to a change history. The operator can visually recognize a measure (a change instruction) that has actually been taken to suppress the chatter vibration.

In addition, the operator can apply a change to a machining program by using the adjusted item check screen 194a. Because the operator only needs to tap the buttons 198, 202, and 204 displayed on the adjusted item check screen 194a, update of a machining program can be easily performed. Furthermore, because the operator need not manually open each machining program to check individual changes to be made, such human errors as erroneously rewriting a program by the operator in updating a machining program can be prevented. This is particularly effective in a case where a machining program includes a large number of blocks. Furthermore, because codes before changes are made to update a machining program remain in the form of commented-out codes, an updated machining program can be easily returned to that before the update.

### <Modifications>

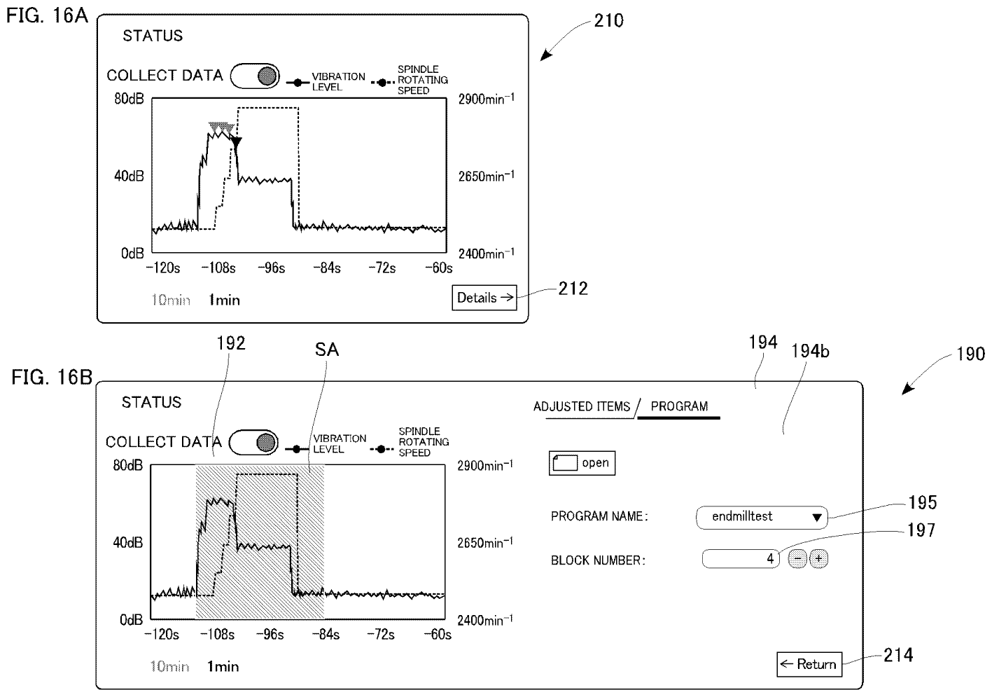

FIGS. 16A and 16B are diagrams illustrating a change history check screen according to a first modification. FIGS. 16A and 16B illustrate an example of screen transition.

In this modification, a Details button 212 is provided in a lower right region on a status screen 210 (FIG. 16A). When the operator taps the Details button 212, a change history check screen 190 opens (FIG. 16B). In addition, a Return button 214 is provided in a lower right region on the change history check screen 190 (FIG. 16B). When the operator taps the Return button 214, the change history check screen 190 is closed and the display returns back to the status screen 210 (FIG. 16A).

An adjusted item tab and a program tab are provided in an upper part of the operation screen 194. The screen is switched when either of the tabs is selected. In the illustrated example, the program tab is selected, whereby the program check screen 194b is displayed.

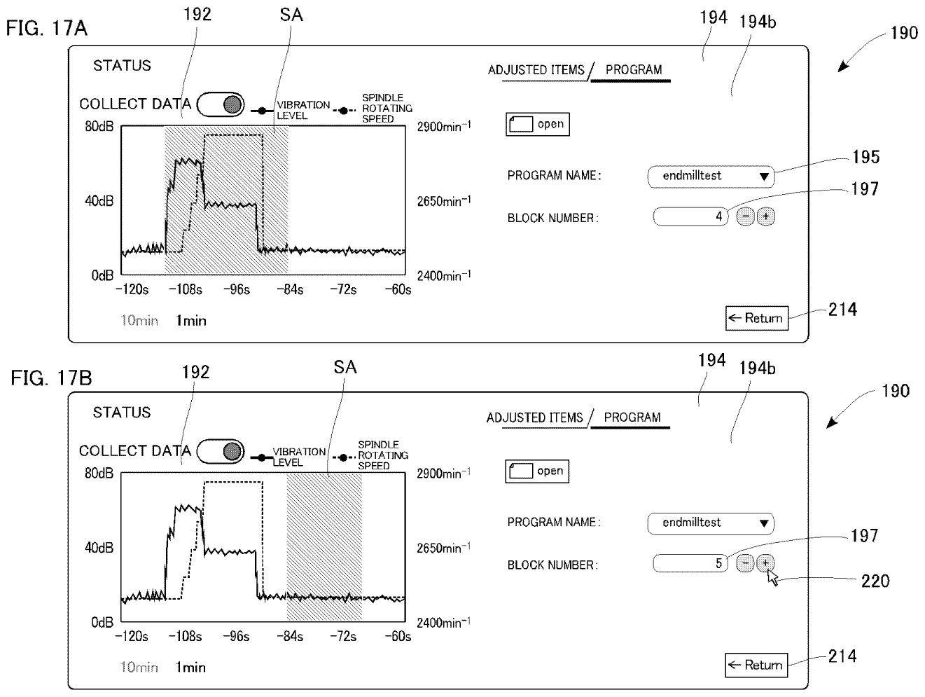

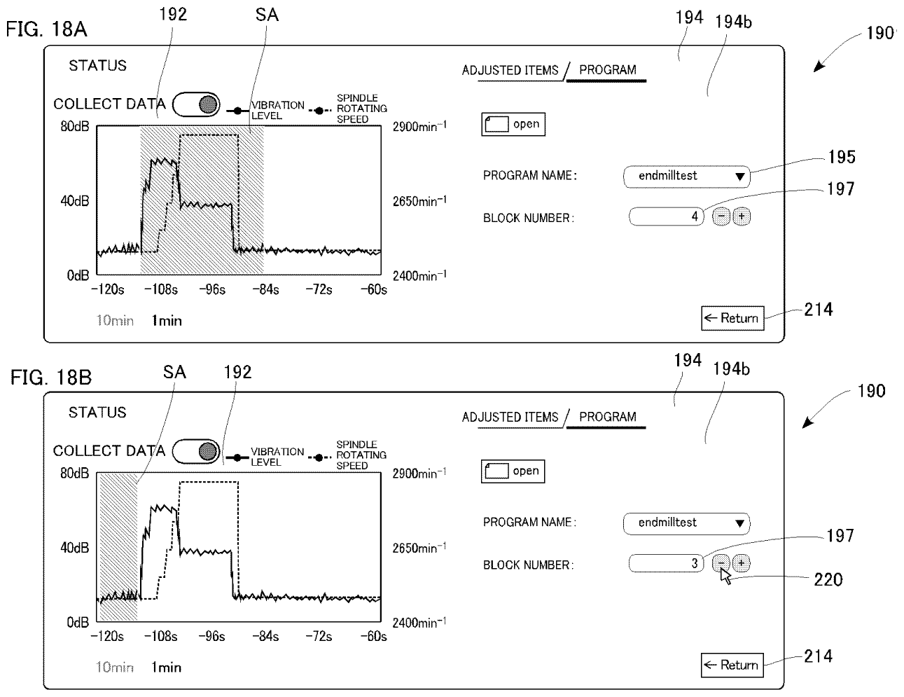

FIGS. 17A, 17B, 18A, and 18B are diagrams illustrating screen transition of the program check screen.

When a + button or a − button is used to increase or decrease the block number on the program check screen 194b, the display control unit 158 causes a region identifying display SA associated with the block number to be displayed on the control history screen 192. For example, by pointing the + button with a cursor 220 and tapping the + button while a region identifying display SA associated with a block number “4” is displayed (FIG. 17A), the operator can change the block number to “5” so that a region identifying display SA associated with the block number “5” is displayed (FIG. 17B).

By pointing the − button with the cursor 220 and tapping the − button while the region identifying display SA associated with the block number “4” is displayed (FIG. 18A), the operator can change the block number to “3” so that a region identifying display SA associated with the block number “3” is displayed (FIG. 18B). Alternatively, such a change of the block number can also be made by a key input of a block number (a numerical value) in the block selection part 197 instead of selection of the + button or the − button with the cursor 220 as illustrated.

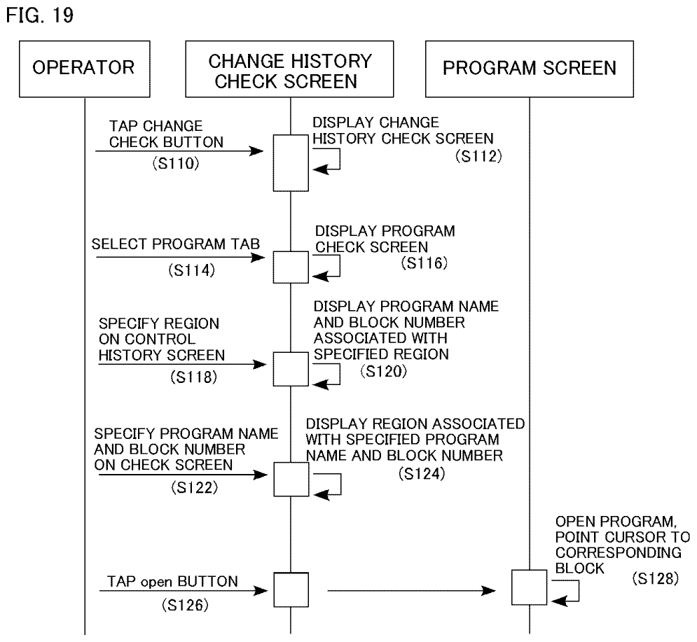

FIG. 19 is a sequence diagram of a change history check process according to a second modification.

When a change check button (not illustrated) is selected by the operator (S110), the display control unit 158 causes the change history check screen 190 (see FIG. 9) to be displayed (S112). When the program tab is selected by the operator (S114), the display control unit 158 causes program check screen 194b to be displayed (S116).

In this state, when a region is specified by the operator by touching a part of the control history screen 192 (S118), for example, the display control unit 158 causes a program name and a block number associated with the specified region to be displayed on the program check screen 194b (S120).

Conversely, when a program name and a block number are specified on the program check screen 194b by the operator (S122), the display control unit 158 causes a region identifying display SA to be displayed as being superimposed on a region associated with the program name and the block number on the control history screen 192 (S124).

When the open button 199 is selected by the operator (S126), the display control unit 158 causes the program screen 196 to be displayed with a cursor pointing the corresponding block number (S128).

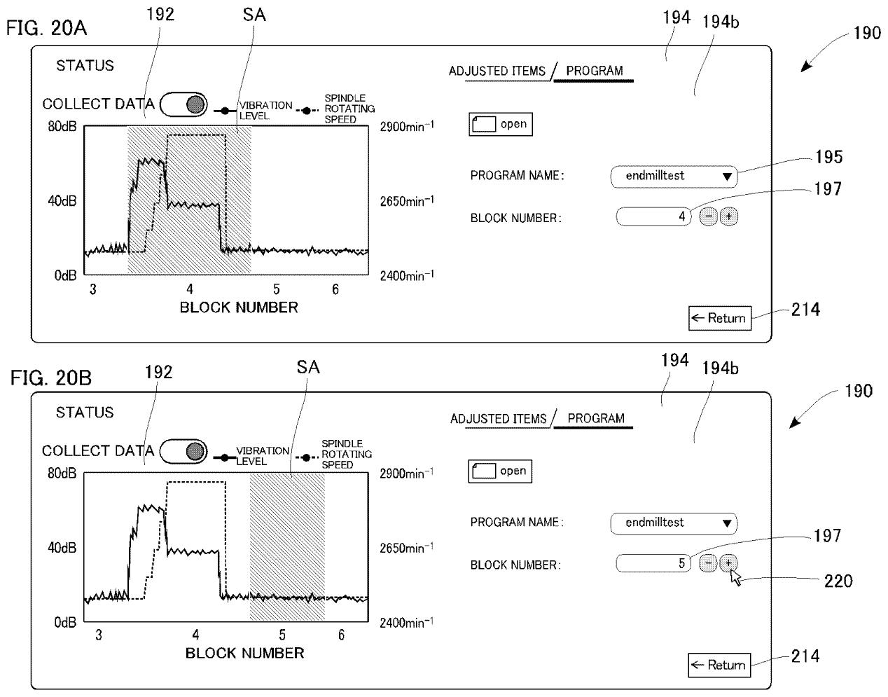

FIGS. 20A and 20B are diagrams illustrating screen transition of a program check screen according to a third modification.

In this modification, in display of the program check screen 194b, a horizontal axis representing the block number and a vertical axis representing the spindle rotating speed and the vibration level are displayed on the control history screen 192. When the block number is increased or decreased on the program check screen 194b, the display control unit 158 causes a region identifying display SA associated with the block number to be displayed (FIGS. 20A and 20B). The display of a region identifying display SA associated with a block number is similar to that in the first modification described above (see FIGS. 17A, 17B, 18A, and 18B).

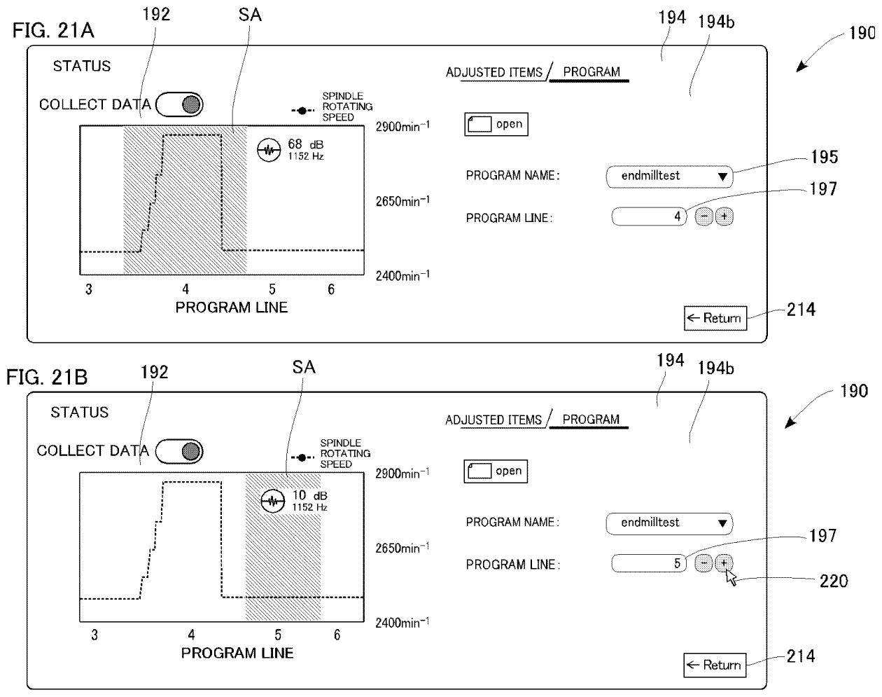

FIGS. 21A and 21B are diagrams illustrating screen transition of a program check screen according to a fourth modification.

In this modification, in display of the program check screen 194b, a horizontal axis representing the program line and a vertical axis representing the spindle rotating speed are displayed on the control history screen 192. When the program line number is increased or decreased on the program check screen 194b, the display control unit 158 causes a region identifying display SA associated with the program line to be displayed (FIGS. 21A and 21B). The display of a region identifying display SA associated with a program line is similar to that in the third modification described above (see FIGS. 20A and 20B).

In this modification, however, although the change in the vibration level is not displayed on the control history screen 192, but a highest value [dB] of the vibration level when a selected program line is executed is displayed as a numerical value (FIGS. 21A and 21B). In the example of FIG. 21A, a vibration level of 68 [dB] and a peak frequency of 1152 [Hz] are shown for a program line “4”. In the example of FIG. 21B, a vibration level of 10 [dB] and a peak frequency of 1152 [Hz] are shown for a program line “5”. Alternatively, the program line in this modification may be replaced by the block number.

### <Other Modifications>

In the above-described embodiment, a control-command spindle rotating speed has been described as an example of a control command value. Additionally or alternatively, a command value of a spindle feed rate (a command feed rate) may be included in time-series data. Such time-series data shows which of the spindle rotating speed and the spindle feed rate is the major factor of a chatter vibration.

In the above-described embodiment, an example has been described in which the second or third status screen displays other parameters, such as the block number and the peak frequency, in time-series data while display of a command spindle rotating speed is turned off. In a modification, the other parameters may be displayed in a superimposing manner while display of the control-command spindle rotating speed is maintained.

In the above-described embodiment, an example has been described in which a tuning screen is displayed and, when a chatter vibration has occurred, a recommended change value of the spindle rotating speed is calculated internally in the machine tool. In a modification, an operator may make a change on the basis of their own sense. In this case, the tuning screen may be omitted. Specific examples of this case include a case where an operator has manually operated an override switch provided on a console of a machine tool to change a control command value. In this case, information on the measure against the chatter vibration is automatically recorded in the machine tool and is displayed in a superimposing manner, thereby allowing the operator to reflect the information in subsequent measures against chatter vibrations.

In the above-described embodiment, an example has been described in which the detection unit 116 includes the vibration detection unit 130 and the rotating speed detection unit 132, and the display control unit 158 causes time-series data indicating changes in the detected vibration level and the detected spindle rotating speed to be displayed as a status screen. In a modification, a load detection unit may be included as the detection unit. The load detection unit detects a load applied to a tool. The “load applied to a tool” may be a torque load or a cutting force. A load (a drive load) on a motor that rotates the spindle onto which a tool is attached or a cutting force may be detected as a “load applied to a tool”. A vertical axis representing the load applied to a tool may be displayed on a status screen. In addition, a display control unit may cause time-series data including a change in the detected load level to be displayed on a status screen.

For example, when the load is high, an operator may make a change to lower the feed rate. Such a change history may be recorded, so that operators can check it afterwards. In addition, the change may be applied to a machining program.

Specifically, the detection unit detects a control state including at least one of the vibration of and the drive load on a tool. The display control unit may perform control to display time-series data indicating changes in the control state detected by the detection unit as a control history screen. When an instruction to change at least one of the rotating speed and the feed rate is then received, the display control unit may cause a marker indicating the change instruction to be displayed as being superimposed on the time-series data on the control history screen.

Although not mentioned in the above-described embodiment, at least one of a load applied to the spindle of the machine tool and a load applied to a shaft (feed shaft) of the feed mechanism may be detected, and the load on the tool may be calculated or estimated on the basis of the detected load. More specifically, a driving current of the spindle motor that rotates the spindle or a driving current of the servomotor that rotates the feed shaft may be detected, and the load on the tool or the vibration of the tool may be detected on the basis of the detected current value. The control device 50 illustrated in FIG. 2 may include a “detection unit” that detects the driving current.

Although not mentioned in the above-described embodiment, when a user has selected (tapped) any region of the time-series data on the control history screen 192 (scc FIG. 11) with a cursor or a finger, for example, a region identifying display SA may be displayed in the selected region. In this case, the block number in the block selection part 197 on the program check screen 194b is changed to the selected block number. In the example of FIG. 11, a block number “4” is selected, and a region identifying display SA is displayed in a region associated with the block number “4” on the control history screen 192. When a region associated with a block number “5” on the control history screen 192 is selected in this state, the display control unit 158 displays a region identifying display SA is the selected region, and changes the display in the block selection part 197 to “5”. In this manner, the control history screen 192 may function as “a receiving unit to receive a predetermined input based on time-series data”.

In the modifications illustrated in FIGS. 20A, 20B, 21A, and 21B as well, when a user has selected (tapped) any region on the control history screen 192 with a cursor or a finger, the display control unit 158 may display a region identifying display SA indicating a block number or a program line in the selected region. In this case, the display in the block selection part 197 on the program check screen 194b is changed to the selected block number or program line.

In the above-described embodiment, a horizontal machining center has been described as an example of the machine tool 1. In a modification, the machine tool 1 may be a vertical machining center. Alternatively, the machine tool 1 may be a turning center or a combined machine having both of the functions of the machining center and the turning center. The above-described display control for suppressing a chatter vibration may be applied to these machine tools.

In the above-described embodiment, the display control device applied to the machine tool 1 has been described. In a modification, the display control device may be applied to equipment other than machine tools. Specifically, only the functions of the display control unit 158 illustrated in FIG. 3 may be included in a separate display control device.

The present invention is not limited to the embodiments described above and modifications thereof, and any component thereof can be modified and embodied without departing from the scope of the invention. Components described in the embodiments and modifications can be combined as appropriate to form various embodiments. Some components may be omitted from the components presented in the embodiments and modifications.

This application claims priority from Japanese Patent Application No. 2022-001683 filed on Jan. 7, 2022, the entire contents of which are hereby incorporated by reference herein.

1. A display control device for controlling display of a state of a machine tool which includes (i) an attachment portion to which a tool is attachable, (ii) a numerical control unit for controlling a rotating speed of the tool in accordance with a machining program, and (iii) a detection unit for detecting at least one of a vibration of the tool and a load applied to the tool, the display control device comprising:
a display control unit for controlling display of time-series data indicating a change in a detected value detected by the detection unit in a process of execution of the machining program; and
a receiving unit for receiving a predetermined input based on the time-series data,
wherein the display control unit controls display of (a) a program name and (b) at least one of a block number and a program line of the machining program associated with the predetermined input received by the receiving unit.

2. The display control device according to claim 1, wherein
the display control unit displays a region associated with the block number as being superimposed on display of the time-series data.

3. The display control device according to claim 1, wherein
the display control unit displays a region associated with the program line as being superimposed on display of the time-series data.

4. A display control device for controlling display of a state of a machine tool which includes (i) an attachment portion to which a tool is attachable, (ii) a numerical control unit for controlling a rotating speed of the tool in accordance with a machining program, and (iii) a detection unit for detecting at least one of a vibration of the tool and a load applied to the tool, the display control device comprising:
a display control unit for controlling display of time-series data indicating a change in a detected value detected by the detection unit in a process of execution of the machining program; and
a receiving unit for receiving a predetermined input based on the time-series data,
wherein the display control unit controls display of the time-series data indicating the change in the detected value detected by the detection unit, and (a) a program name and (b) at least one of a block number and a program line of the machining program associated with the predetermined input received by the receiving unit.

5. A machine tool comprising:
an attachment portion to which a tool is attachable;
a numerical control unit for controlling a rotating speed of the tool in accordance with a machining program;
a detection unit for detecting at least one of a vibration of the tool and a load applied to the tool;
a display control unit for controlling display of time-series data indicating a change in a detected value detected by the detection unit in a process of execution of the machining program; and
a receiving unit for receiving a predetermined input based on the time-series data,
wherein the display control unit controls display of (a) a program name and (b) at least one of a block number and a program line of the machining program associated with the predetermined input received by the receiving unit.
